(19) United States
(12) Patent Application Publication
(10) Pub. No.: US 2014/0017652 A1
(43) Pub. Date: Jan. 16, 2014

(54) MEMORIZING MECHANISM FOR ENHANCING AND IMPROVING A PRESENTATION BY A SPEAKER, PROFESSIONAL PERFORMER, OR STUDENT

(71) Applicant: Maurice Laurence Henri Perdreau, Beacon, NY (US)

(72) Inventor: Maurice Laurence Henri Perdreau, Beacon, NY (US)

(21) Appl. No.: 13/546,565

(22) Filed: Jul. 11, 2012

(51) Int. Cl. G09B 7/00

(52) U.S. Cl. 434/322

(57) ABSTRACT

This application is a one-person learning device to facilitate memorization in a series of reward features, hints, and personalized choices that might be color-coded by level of difficulty, a rate-limiting timer feature, and/or a wireless teleprompter-like feature. It removes assistance of a second person in the method of prompting actors, speakers, orators, performers, and students for a word. It may highlight and/or auto-reveal publicly available text or personally inputted text word by word. A portion of the dictation to be received by the subscriber can be predetermined, time-limited, list-defined, and color-coded, described in the embodiments above or any combination of the Memorizing© game, with additional feature to improve and/or enhance the memorizing prompting experience.

### BACKGROUND

Prior to this invention, actors, actresses, speakers, orators, performers, and students had to stare at a page for hours and repeat lines in their head over and over again until they got it right. This was the ancient, timeless method of memorization used since ancient Greece. Another way to memorize was memorizing audibly through dictating and re-listening to a text until you were able to recall it. Going back to the age before the printing press, memorization was most likely passed on through word-of-mouth from generation to generation. Until this invention, there was no role of technology in the retention of learning that dealt with memorizing in a natural and organic form that took the benefits and best practices of traditional memorizing. From the experience of being an actor, the ancient process of memorizing was ineffective, time consuming, and boring. Clearly, there was a need to bring the process into the 21^{st} century.

This invention revolutionizes the methodology and processes of how one recalls and retains the written word. In addition, this invention recognizes the ancient form of audible learning as well as the current audible memorization technology and incorporates it into a form that is based on the main benefits of visual learning. Furthermore, it seamlessly incorporates both visual and audible learning to assist the actors, actresses, speakers, orators, performers, and students to achieve their memorizing, learning, and retention goals. This invention may also help as a language learning tool to learn words, phrases, and texts in foreign languages. This invention removes the need for a second person to prompt an actor (a user) on perhaps a movie set to say the correct lines. A portion of the dictation to be received by the user can be predetermined, time-limited, list-defined and color-coded, as described as in the embodiments below or any combination of the Memorizing© game, with additional features to improve and/or enhance the memorizing prompting experience. Therefore, this invention meets a critical need in the market.

### SUMMARY

This invention is a device for memorizing with a word input device, a word output device, a program to facilitate transfer some or all information between said input device and said output device and a Memorizing© program controlling said input device and output device.

### DESCRIPTION OF THE DRAWINGS

FIG. 1A. This drawing shows this first functional page of the invention. This illustration is of the home page.

FIG. 1B. This illustration shows the home page button that appear on every screen FIG. 2. This drawing shows what occurs when the user presses the “Shakespeare” category. This illustrates the results of the choice.

FIG. 3. This drawing demonstrates what possible choices may occur after the user presses “Men's Monologues.”

FIG. 4. This drawing shows a possible text choice that occurs after the user presses “Hamlet 3.1.” Illustration shows choices “reference” and “beat it.”

FIG. 5. This drawing shows what occurs after the user presses “reference.” This illustration demonstrates a “read only” frame and not the game frame.

FIG. 6. This drawing shows what occurs after a user picks his features for the game. This illustration demonstrates the game-playing highlighted text of choice. Other possible game playing choices are also illustrated here.

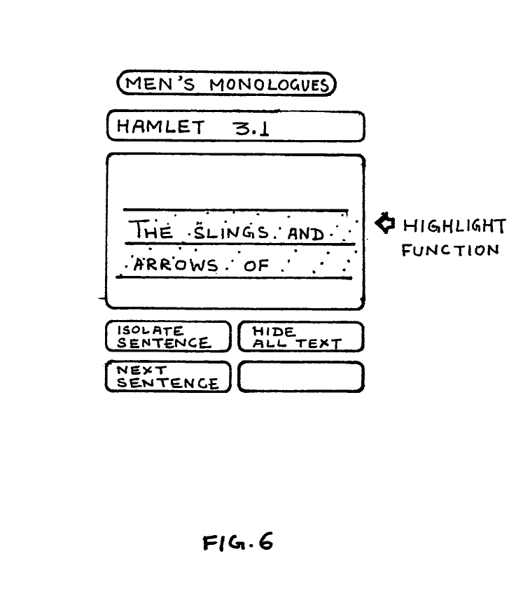

FIG. 7. This drawing shows what occurs after the user presses “isolate sentence.” Player choices range from at least a word, a group of words, or a phrase.

FIG. 8. This drawing shows what happens when the user presses “hide sentence.” A player can use at least these illustrated choices to test if the text has been memorized. The player may press “got the word” to reveal word-by-word what he has just mastered and it scores him a point. The player may also lose points when he presses “show sentence.” If the “hint” button is pressed, the player does not lose points but the player does not receive a point for the word.

FIG. 9. This drawing shows the “option” page that lists the features available before or after the user plays the game. The illustrated “Difficulty Folder” option allows the player to group together text to memorize by range of difficulty. “Button Option” allows movement or placement of buttons. The rest of the buttons are self-explanatory.

FIG. 10. This drawing shows an overview of how the functionality of the game works. Any software developer would develop the application through this flow chart as a further aid.

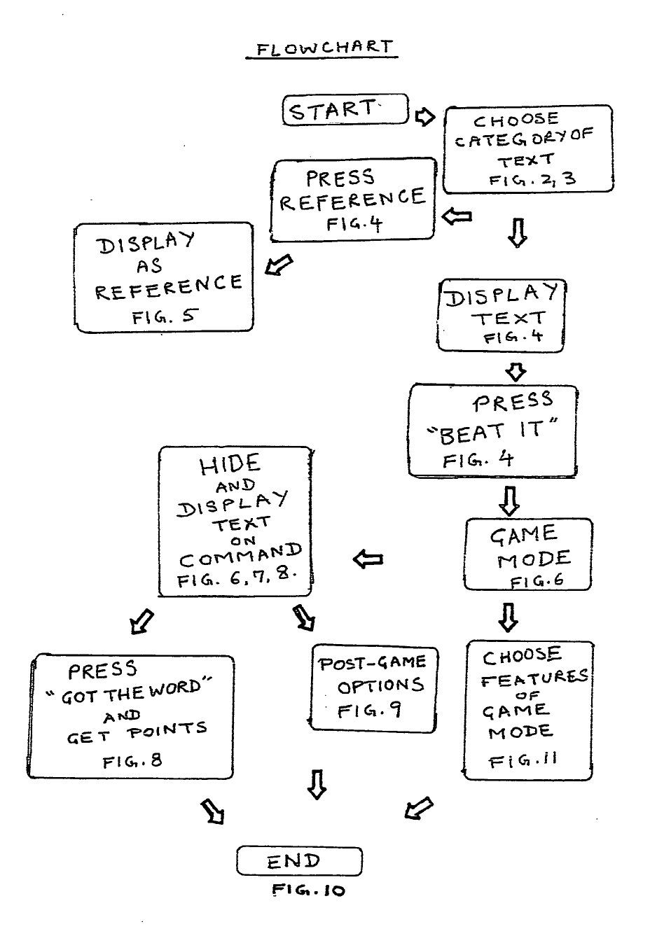

FIG. 11. This drawing shows what occurs after the user presses “beat it”[[.]] as illustrated in FIG. 4. It shows the text the user has selected and various ways to play the game with the text to get points in mastering memorization. The “voice recognition” feature will recognize at least the word the user has said and will progress through the game automatically. “Manual” takes you to FIG. 8 options.

### DETAILED DESCRIPTION OF INVENTION

To the best of my knowledge, I am the only inventor of Memorizing© for actors actresses, speakers, orators, performers, and students. There was a need in the market for such a technological device.

This invention is similar to a flashcard system displayed through a technological device. Flashcards are one of the best traditional ways of learning material. However, when you are trying to memorize a speech through a flashcard system, you need as many flashcards as there are words. Equally, the process of learning a speech through traditional flashcards would be unreasonably time-consuming, cumbersome, and the order of the cards could easily get out of sequence or out of order. This invention seamlessly utilizes state of the art technology and turns any text instantly into a flashcard system, which may be displayed in modern wireless, mobile, or desktop devices. Any person in the arts would recognize that it is not limited to the aforementioned devices.

This invention is particularly of use to the deaf and the blind. The optional addition of an audible input or output of the flashcard material would aid in a memorization tool for someone with blindness or deafness.

This invention achieves a tool to play a word game that facilitates memorization. One of the main tools in the app is that you can highlight portions of the desired text to memorize the piece. The memorization process is that you have to focus on a text almost sentence by sentence. The invention reveals the words the user gets correct as they proceed with the text. One key feature is that the text starts over from the beginning once the user inputs that he needs to reveal the text again. In memorization, the fact that the user was able to recall half of the sentence is irrelevant. The value in memorization is being able to recall the whole sentence or group of sentences. The goal of the invention is to achieve that aim.

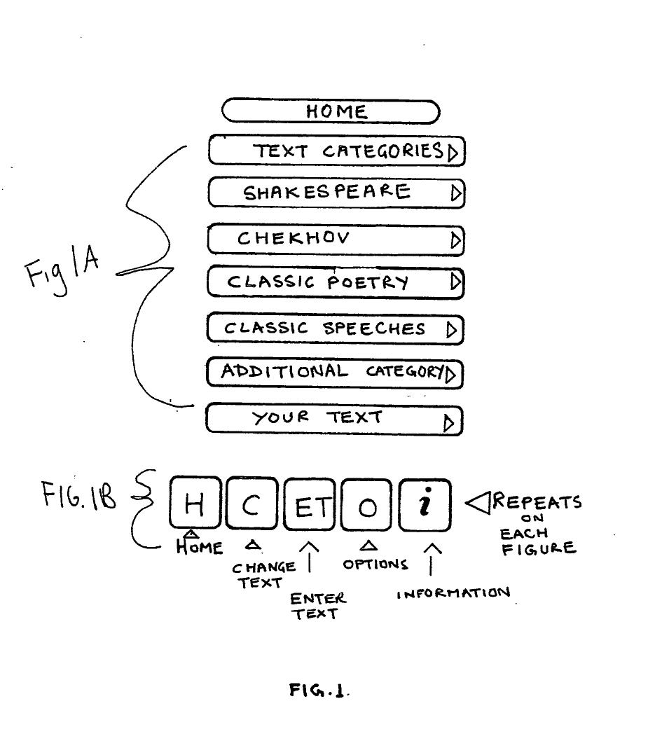

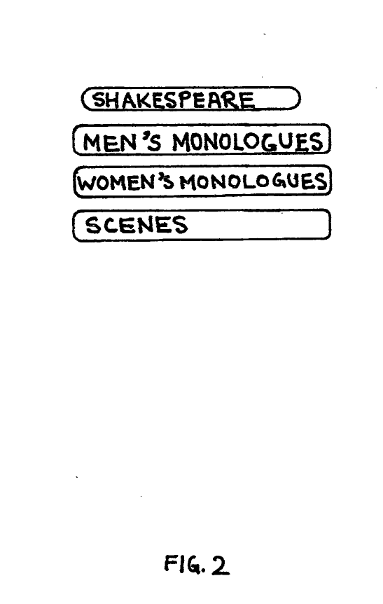

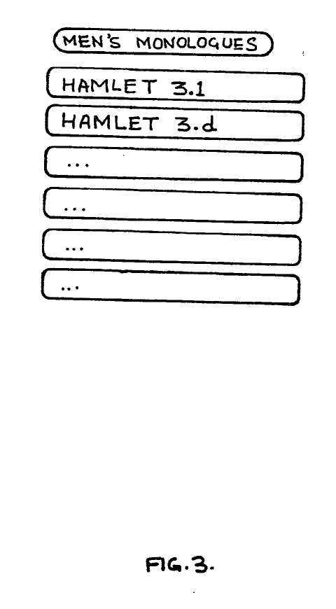

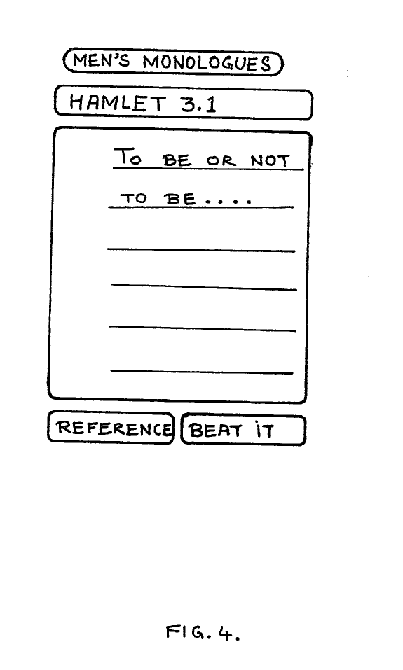

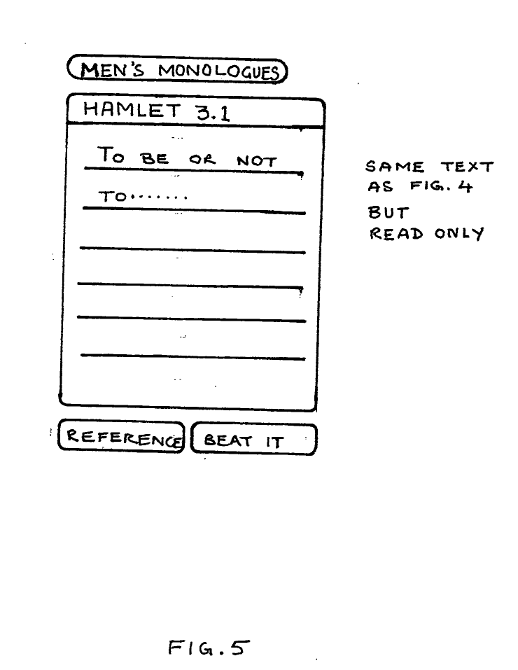

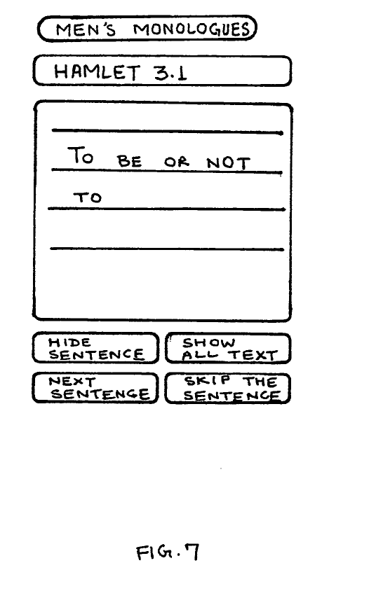

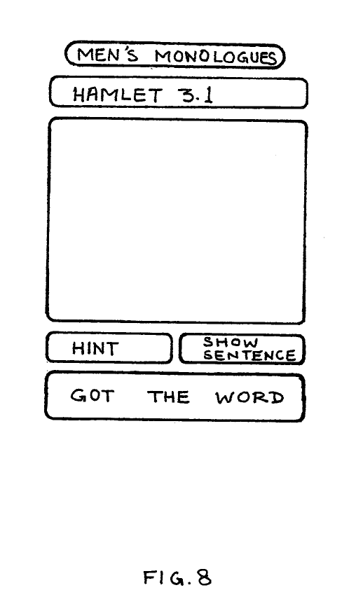

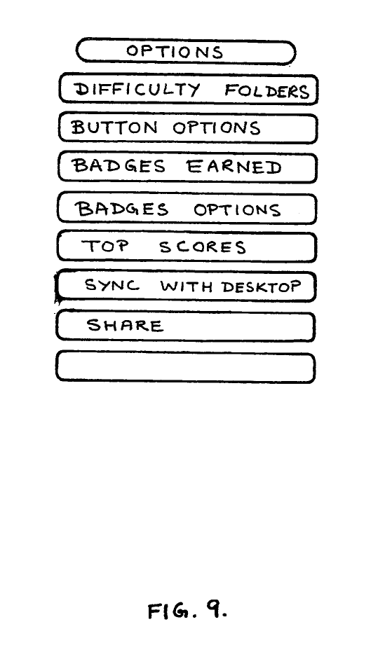

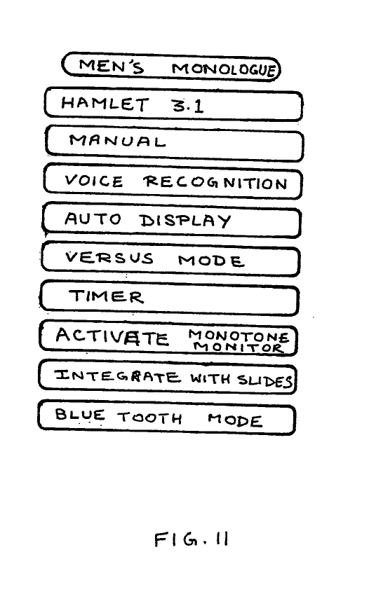

One embodiment of how this invention works is the following steps and further improvements also listed below:
1. This invention shows the home page giving you choices between categories of text to choose from. (FIG. 1A) For example the choices might include works from Shakespeare, Anton Chekhov, classic poetry such as Wordsworth, and classic speeches such as the Gettysburg Address. Additionally, the user can input any text he or she desires under the “your text” function.
2. This invention shows the chosen category displaying the subcategory (FIG. 2). An example of the sub-category of Shakespeare would be “men's monologues,” “women's monologues” or “scenes.” This embodiment of the invention is assisted by a feature of the invention that provides preloaded texts from the public domain assisting in linking to, for example, a scene of interest.
3. This invention shows possible further sub-categories. For example, men's monologues could include a further sub-category of A Midsummer Nights Dream or Hamlet, which come preloaded (FIG. 3). A further subcategory might include the act and scene numbers.
4. This invention shows the desired text. (FIG. 4) Shakespeare→men's monologue→play→scene number→desired text. Additionally, once you are reading the text the true value of the invention begins. Here, you have the option of utilizing the text under the possible button names as “reference” or as a game (under the button “beat it.”)
5. First pressing the “beat it” button could bring you to the features that could be available for this invention. (FIG. 11) For example, there could be “manual,” “voice recognition,” “auto display,” “versus mode,” “timer,” “activate monotone monitor,” “integrate with slides,” and/or “Blue Tooth.”
6. The reference button leads you to a static page where the user can examine the text as a “read only” function. (FIG. 5
7. The “beat it” button, or any button that starts the functionality of the game, takes you to a page where the user has the opportunity to highlight the desired text to be used for the memorization game. (FIG. 7)
8. When the user presses the “isolate sentence” button, the selected text appears in isolation, where the user will now commit the text to memory. (FIG. 8)
9. This invention contains various options that could be available before or after the user plays the game. (FIG. 9) For example, there could be buttons of “difficulty folders,” “button options,” “badges earned,” “badges options,” “top scores,” “sync with desktop,” and “share.”
10. After the text is put to memory, the user can quiz himselves using the flashcard system by pressing “got the word,” or any named text that would reveal the word, every time he gets the word correct, then the following word that he recalled reveals itself. Every time the user presses “got the word” the user receives one point, some points, or a reward system, the points are erased if the user reveals the text to himself before completing it. If the user cannot recall the words, the user can press “hint” or “show sentence.” The hint button reveals the following word for a split second; the user does not receive points for hint words. This allows you to show the next word without showing the whole sentence, it shows the sequence of words in increasing order until you recall the full sentence and hit “got the word.” Pressing “show sentence” reveals the full sentence and the user starts over again from the beginning, loses points received previously, and must start over again. The user repeats this process until he has memorized the whole or portion of the text.
11. The user has a choice to go back to the home page or as an improvement to directly the previous screen.
12. The user can stop or end the Memorizing© game by pressing a stop or end game function.

Another embodiment of this invention could be to allow two or more players or users to race each other to memorize the same text using one or more of the above steps. This embodiment could possibly be called “Memorizing with Friends.” The rewards system would recognize the winner and possibly add previous or future tallies of a similar memorizing game.

Another embodiment of this invention might be an option to print out a) the whole text to be memorized, b) the highlighted portions of text to be memorized, and/or c) the portions of text one is having difficulty with.

Another embodiment of the invention could transfer the portions that the user is having difficulty with to a list or a folder. The user can list the problem areas and be able to transfer it to a different folder or folders by a user-chosen category, sub-category, or user-defined category.

Another embodiment would be differentiating a portion of the text to be memorized in the following way:
1. The invention could be able to track portions of previous games and demonstrate the level of difficulty the user previously had with the section. This invention could include a rainbow of colors correlating to the level of difficulty the user previously had with the previous text. For example, green could be low difficulty, red could be medium difficulty, and purple could be high difficulty. This embodiment could interact with the prior embodiments and automatically list by color or level of difficulty. For example, one could choose to focus on memorizing solely the red level of difficulty.

Another embodiment of the invention would be incorporating the voice recognition tools available in the market and to have a function to recognize the words the user says or to output the text to be memorized using an audible feature or in brail. The voice recognition function could incorporate all of the above features in a hands-free manner, where the invention would perform all the above steps and embodiments through voice recognition.

A feature of this invention relies on the mode of entry by the user. An ergonomic design places the function in a better design for superior user interaction of this invention by the user. The invention could move the buttons differently to best shape the user experience depending on the specific device. The location of the buttons would depend on the design of the device. For example, the “got the word” button or the “back” button might be moved around. A particular design feature that might be changed could be the “got the word” button. For example, the “got the word” function on the iPhone™ could be where the user familiarly uses his thumb for the keyboard but it could be somewhere else on another device. The invention leaves the option open to relocate, rename, and redefine the positions of the user interface buttons. The invention also leaves the option open for the user to be able to relocate the buttons for the user interface. Furthermore, the invention also leaves the option open to design increasing or decreasing choices or user interface button for this memorizing invention. For example, this invention might include creating your own button choice.

The user can develop his own prompts and badges as a reward system based on the number of points and speed in which he memorizes. There will be pre-loaded badges installed with the app that can be shared on social media or in email. For example, a school or a group might want to create their own badges or buttons to facilitate their own memorizing ambitions and goals. A professional actor using this invention might want buttons specifying scenes of interest or plays and characters he or she is interested in getting recognition for.

Another embodiment of this invention is having a timer feature. For example, possible uses could be:
1. An allotted time period to memorize of a different color.
2. An allotted time to deliver a specific speech. Some passages to memorize mater the speed to which the user delivers them, this feature would address the problem.
3. The user can also use the time to determine how many words he or she can memorize over a certain time period. The metric to measure this statistic could be words memorized per minute.

Another embodiment of this invention could track the pauses and inflections that the user delivers the speech. Memorizing a speech with the same tones, pauses, and inflections can be detrimental to the delivery. The invention could feature a warning sign if the delivery is too static, too monotone, or delivered in the same repetitive manner. The invention could have a graph, perhaps voice recognized and/or time recognized, where the user can track the quality of the delivery.

Another embodiment of this invention could include delivery without the aid of using the invention as traditionally described above. For example,
1. A teleprompter-like feature that might include hints instead of entire sentences as described in the hint feature in the steps above.
2. A teleprompter-like feature that only features the introduction and conclusion of a speech and could equally give preselected/user-selected hints that may be color-coded.
3. A feature might include full-length hints to passages for highest level of difficulty.
4. Should the speaker include slides in the presentation such as in a family reunion, traditional presentation, PowerPoint presentation, or any feature involving visual images. The hints or Memorizing© game can be applied to the coordinate the visual presentation with the desired text to be memorized.

Another embodiment of this invention could incorporate Blue Tooth, wireless, and state of the art technology to create an auto-dictate feature. For example, a user's removable contraption might be placed on the body of the speaker, perhaps within the ear of the user, which could receive dictation controlled by the user from the memorizing invention. A portion of the dictation to be received by the user can be predetermined, time-limited, list-defined, and color-coded, as described as in the embodiments above or any combination of the memorizing game, with additional features to improve and/or enhance the memorizing prompting experience. Those in the arts know that currently in movies another person will prompt an actor through an earpiece to tell him what to say, currently in movies a second human being is needed for this. This invention removes the need for a second person to prompt the user (actors, actresses, speakers, orators, performers, and students) on perhaps a movie set, any speech, performance, or an oral presentation, to say the correct lines to say. This feature is applicable to anyone giving a speech where the user could self-feed himself user-predetermined audible lines as they give the speech. For example, in the Gettysburg Address, Lincoln could have used the invention to say in his ear, “Four score (press app to dictate the following line audibly on contraption) and seven years ago, (press app again to reveal next line audibly on contraption) our fathers brought forth on this continent . . . . ”

Another embodiment of this invention includes an option or ability to copy and paste or transfer text information with any state of the art method between the desktop application, the mobile device, or any state of the art device displaying the Memorizing© feature and/or any of the embodiments above. This invention may include a “sync” button to enable the above feature.

Yet another embodiment of the invention includes a function that does not need the user to press buttons to control the flow of the game; the auto feature could be preselected utilizing a series of predetermined speeds or could be independently set up through a series of choices to personalize the degree of independence of control over the memorization process. Again, this feature could be enhanced when the user is able to choose the rate of the use of the buttons at the level that the user desires. The words, preselected phrases, or color-coded phrases might be set by the user to appear automatically, at a rate predetermined by the user. The metric that could be used for this statistic, for example, are words per second, words per minute, or seconds per word. The timer described above can also be preselected to coordinate the functionality of the auto reveal. The wireless or Blue Tooth feature described above might seamlessly coordinate with this auto feature and automatically deliver the words during the memorization process into directly inside perhaps the ear of the user. The portion of the dictation to be received by the user can be predetermined, time-limited, list-defined, and color-coded, as described as in the embodiments above or any combination of the memorizing game, with additional feature to improve and/or enhance the memorizing prompting experience.

This invention could forever change the way, say for example, a valedictorian makes a speech going into the future.

It is to be understood by those in the state of the art that this invention is not limited to those uses and users described above.

I claim:

1. A device for memorizing comprising
a. a word input device;
b. a word output device;
c. a memorizing program to facilitate transfer of all information said input device and said output device;
d. a memorizing program controlling said input device and said output device;
e. wherein the said input device and said output device may be various combinations of one or more devices selected from the group comprising of a mobile device, a desktop device, or a wireless apparatus; and
f. wherein said memorizing program assists the user to remember the said input memorizing program transferred input memorizing information.

2. (canceled)

3. A device for memorizing as in claim 1,
comprising
a. an ergonomic design placing the functions for easier texting, and
b. placing the said “got the word” function, if present, closer to where people will actually have their thumbs for easier texting with said ergonomic design.

4. A device for memorizing as in claim 1,
comprising
said desktop device having all functionality of the said mobile application.

5. A device for memorizing as in claim 1,
comprising
said mobile application having all functionality of the said desktop application.

6. A device for memorizing as in claim 1,
comprising
said output application has a said “got the word” feature, showing said input information, said word or said phrase had been memorized by the user, has been accepted.

7. A device for memorizing as in claim 6,
comprising
said mobile application and desktop application eliminate said “got the word” or need to press said “got the word” feature, with an automatic said memorizing program assisting the user to set a pre-determined rate to move on to the next step.

8. A device for memorizing as in claim 1,
comprising
an ability for the reader to be able to set the rate at which said words are auto revealed.

9. A device for memorizing as in claim 8,
comprising
an ability where said words will be auto revealed by themselves and this feature may be optional or included.

10. A device for memorizing as in claim 1,
comprising
an option to react or respond to said word.

11. A device for memorizing as in claim 1,
comprising
the program is set to hear one or more syllables or said words and an optional pause and will automatically reveal the full said word or phrase with a preset output function to assist in memorizing.

12. A device for memorizing as in claim 1,
comprising
the program is set to have a function to recognize the said word or phrase or pause the user says or inputs between said words or said phrases to assist in memorizing.

13. A device for memorizing as in claim 6,
comprising
a. said “got the word” or any function button showing said input information, said word or said phrase has been memorized by the user, has been accepted, is located near the other key function buttons or at a location wherein it is easier for the user to reach and indicate that the user has memorized said word or phrase and wishes to move on to the next said word or said phrase; and
b. this said move on step may be either manually controlled by the user or programmed to be automatically controlled at a rate pre-determined by user.

14. (canceled)

15. (canceled)

16. A device for memorizing,
comprising
a. an ability to easily facilitate the transfer of said input memorizing information between the said mobile device to and from said desktop device,
b. an ability to share all functions of the said memorizing program between said mobile application and said desktop application;
c. wherein said input memorizing information may include at least original matter entered by user, public domain matter accessed by user, or original matter written by another, for example a screenwriter or speech writer; and
d. wherein said memorizing program assists the user to remember said input memorizing information.

17. A device for memorizing as in claim 1,
comprising
of a said input memorizing information
a. wherein said input memorizing information may be programmed to be highlighted with a range of at least one or more color choices or numbers to indicate the level of difficulty in memorizing said input memorizing information;
b. allowing user to create a select list by said number or other selection criteria set by a pre-determined set up program; and
c. said range of highlighted color coded or numbered material may be able to further programmed to be either manually or automatically further segregated by level of difficulty assisting the user to concentrate.

18. A device for memorizing as in claim 1,
which comprises of said output device, further comprises of a contraption A with an ability to assist the user at a location of user choice, wherein said contraption A further
a. comprises of an ability to receive or transfer said memorizing information in a manner pre-determined by the user, which may include a said highlighted list of information;
b. said contraption A may be an instrument attached to the body of the user perhaps in the ear of the user and aids the user in receiving said memorizing information at the rate pre-determined by the user or said memorizing program;
c. said contraption A may be an instrument not attached to the body of the user but aids user to receive the text of choice from said memorizing information at the rate pre-determined by the user or said memorizing program;
d. said contraption A may be an instrument that can assist the user in learning how to perform the said memorizing information within the time limit;
e. said contraption A may be an instrument that can assist the user in learning how to perform the said memorizing information with the various levels of intonation or voice inflections of an experienced actor or orator; and
f. said contraption A may be an instrument that can assist the user in learning the said memorizing information at the rate, time, intonation, inflection, and pauses of an experienced actor or performer with a set of cues that may be either pre-determined by the user or by the program.
